(19) United States
(12) Patent Application Publication
(10) Pub. No.: US 2023/0274758 A1
(43) Pub. Date: Aug. 31, 2023

(54) METHOD AND ELECTRONIC DEVICE

(71) Applicant: Sony Group Corporation, Tokyo (JP)

(72) Inventors: Lev MARKHASIN, Stuttgart (DE); Stephen TIEDEMANN, Stuttgart (DE); Stefan UHLICH, Stuttgart (DE); Bi WANG, Stuttgart (DE); Wei-Hsiang LIAO, Stuttgart (DE); Yuhki MITSUFUJI, Stuttgart (DE)

(73) Assignee: Sony Group Corporation, Tokyo (JP)

(21) Appl. No.: 18/017,858

(22) PCT Filed: Jul. 30, 2021
(86) PCT No.: PCT/EP2021/071478

§ 371 Date: Jan. 25, 2023

(30) Foreign Application Priority Data
Aug. 3, 2020 (EP) 20189193.4

(51) Int. Cl. G10L 25/51; G10L 21/0308; G10L 25/18; G10L 25/30; G10L 25/06

(52) U.S. Cl. CPC G10L 25/51; G10L 21/0308; G10L 25/18; G10L 25/30; G10L 25/06

(57) ABSTRACT

A method comprising determining at least one audio event based on an audio waveform and determining a deepfake probability for the audio event.

### TECHNICAL FIELD

The present disclosure generally pertains to the field of audio processing, in particular to methods and devices for audio analysis.

### TECHNICAL BACKGROUND

With the emergence of powerful deep neural networks (DNNs) and the corresponding computer-chips, especially at low prices, the manipulation of image content, video content or audio content became much easier and more widespread. A manipulation of image content, video content or audio content with DNNs (called “deepfakes”) and thus the creation of realistic video, image, and audio fakes has become possible even for non-experts without much effort and without much background knowledge. For example, it has become possible to alter parts of a video, like for example the lip movement of a person, or to alter parts of an image, like for example the facial expression of a person, or to alter an audio file, like for example a speech of a person. This technique could be used for large-scale fraud or to spread realistic fake news in the political arena.

Therefore, it is desirable to improve the detection of audio content that has been manipulated by DNNs.

### SUMMARY

According to a first aspect, the disclosure provides a method comprising determining at least one audio event based on an audio waveform and determining a deepfake probability for the audio event.

According to a second aspect, the disclosure provides an electronic device comprising circuitry configured to determining at least one audio event based on an audio waveform and determining a deepfake probability for the audio event.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 shows schematically a first embodiment of a smart loudspeaker system for audio deep fake detection;

FIG. 2 shows schematically a second embodiment of a smart loudspeaker system for audio deep fake detection;

FIG. 3a shows a first embodiment of a pre-processing unit.

FIG. 3b shows an embodiment of a spectrogram;

FIG. 4 schematically shows a general approach of audio source separation by means of blind source separation;

FIG. 5 shows a second embodiment of a pre-processing unit;

FIG. 6 schematically shows an exemplifying architecture of a CNN for image classification;

FIG. 7 shows a flowchart of a training process of a DNN classifier in a deepfake detector;

FIG. 8 shows an operational mode of a deepfake detector comprising a trained DNN classifier;

FIG. 9 schematically shows an embodiment of an autoencoder;

FIG. 10 shows an operational mode of a deepfake detector comprising an intrinsic dimension estimator;

FIG. 11 shows a deepfake detector, which comprises an DNN deepfake classifier and an intrinsic dimension estimator;

FIG. 12 shows an embodiment of a deepfake detector, which comprises a disparity discriminator;

FIG. 13 shows a deepfake detector which comprises a DNN deepfake classifier and a disparity discriminator;

FIG. 14 shows a deepfake detector which comprises a DNN deepfake classifier, a disparity discriminator, and an intrinsic dimension estimator; and

FIG. 15 schematically describes an embodiment of an electronic device which may implement the functionality of deep fake detection.

### DETAILED DESCRIPTION OF EMBODIMENTS

The embodiments disclose a method comprising determining at least one audio event based on an audio waveform and determining a deepfake probability for the audio event.

An audio event may be any part (or the complete) of the audio waveform and can be in the same format as the audio waveform or in any other audio format. An audio event can also be a spectrogram of any part (or the complete) of the audio waveform, in which case it is denoted as audio event spectrogram.

The audio waveform may be a vector of samples of an audio file. The audio waveform may be any kind of common audio waveform, for example a piece of music (i.e. a song), a speech of a person, or a sound like a gunshot or a car motor. The stored audio waveform can for example be stored as WAV, MP3, AAC, FLAC, WMV etc.

According to the embodiments the deepfake probability may indicate a probability that the audio waveform has been altered and/or distorted by artificial intelligence techniques or has been completely generated by artificial intelligence techniques.

According to the embodiments the audio waveform may relate to media content such as audio or video file or live stream.

According to the embodiments the determining of the at least one audio event may comprise determining an audio event spectrogram of the audio waveform or of a part of the audio waveform.

According to the embodiments the method may further comprise determining the deepfake probability for an audio event with a trained DNN classifier.

The trained DNN classifier may output a probability that the audio event is a deepfake, which may also be indicated as fake probability value of the DNN classifier, and which may in this embodiment be equal to the deepfake probability of the audio event.

According to the embodiments determining at least one audio event may comprise performing audio source separation on the audio waveform to obtain a vocal or speech waveform, and wherein the deepfake probability is determined based on an audio event spectrogram of the vocal or speech waveform.

In another embodiment the audio source separation may separate another instrument (track) or another sound class (e.g., environmental sounds like being in a Café, being in a car etc.) of the audio waveform than the vocal waveform.

According to the embodiments determining at least one audio event may comprise determining one or more candidate spectrograms of the audio waveform or of a part of the audio waveform, labeling the candidate spectrograms by a trained DNN classifier, and filtering the labelled spectrograms according to their label to obtain the audio event spectrogram.

The trained DNN classifier may be trained to sort the input spectrograms into different classes. The processes of linking a specific spectrogram with the class that it was sorted into by the trained DNN classifier may be referred to as labeling. The labeling may for example be storing a specific spectrogram together with its assigned class into a combined data structure. The labeling may for example also storing a pointer from a specific spectrogram to its assigned class.

According to the embodiments determining the deepfake probability for the audio event may comprise determining an intrinsic dimension probability value of the audio event.

An intrinsic dimension probability value of an audio event may be a value which indicates the probability that an audio event audio event is a deepfake, which is determined based on the intrinsic dimension of the audio event.

According to the embodiments the intrinsic dimension probability value may be based on a ratio of an intrinsic dimension of the audio event and a feature space dimension of the audio event and an intrinsic dimension probability function.

According to the embodiments determining the deepfake probability for the audio event spectrogram is based on determining a correlation probability value of the audio event spectrogram.

A correlation probability value of the audio event spectrogram may be a probability value which indicates the probability that an audio event audio event spectrogram is a deepfake, which is determined based on a correlation value between the audio event spectrogram and a spectrogram which is known to be real (i.e. not a deepfake).

According to the embodiments determining the correlation probability value is calculated based on a correlation probability function and a normalized cross-correlation between a resized stored real audio event spectrogram of a recording noise floor and noise-only parts of the audio event spectrogram.

According to the embodiments determining the method may further comprise determining a plurality of audio events based on the audio waveform, determining a plurality of deepfake probabilities for the plurality of audio events, and determining an overall deepfake probability of the audio waveform based on the plurality of deepfake probabilities.

According to the embodiments the method may further comprise determining a modified audio waveform by overlaying a warning message over the audio waveform based on the deepfake probability.

According to the embodiments the method may further comprise outputting a warning based on the deepfake probability.

The embodiments disclose an electronic device comprising circuitry configured to determining at least one audio event based on an audio waveform and determining a deepfake probability for the audio event.

Circuitry may include a processor, a memory (RAM, ROM or the like), a GPU, a storage, input means (mouse, keyboard, camera, etc.), output means (display (e.g. liquid crystal, (organic) light emitting diode, etc.), loudspeakers, etc., a (wireless) interface, etc., as it is generally known for electronic devices (computers, smartphones, etc.). A DNN may for example be realized and trained by a GPU (graphics processing unit) which may increase the speed of deep-learning systems by about 100 times because the GPUs may be well-suited for the matrix/vector math involved in deep learning.

Embodiments are now described by reference to the drawings.

A deepfake is a media content, like a video or audio file or stream, which has been in parts altered and or distorted by artificial intelligence techniques or which is completely generated by artificial intelligence techniques. Artificial intelligence techniques which are used to generate a deepfake comprise different machine learning methods like artificial neural networks especially deep neural networks (DNN). For example, an audio deepfake may be an audio file (like a song or a speech of a person), which has been altered and or distorted by a DNN. The term deepfake may refer to the spectrogram (in this case also called deepfake spectrogram) of an audio file deepfake or it may refer to the audio file deepfake itself. The audio deepfake may for example be generated by applying audio-changing artificial intelligence techniques directly to an audio file or by applying audio-changing artificial intelligence techniques to a spectrogram of an audio file and then generating the changed audio file by re-transforming the changed spectrogram back into audio format (for example by means of an inverse short time Fourier transform).

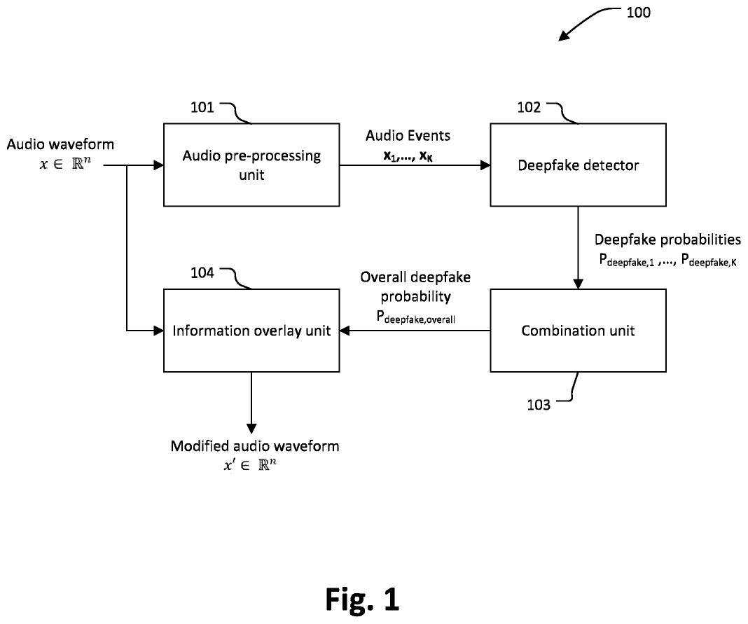

FIG. 1 shows schematically a first embodiment of a smart loudspeaker system for audio deep fake detection 100. The smart loudspeaker system for audio deep fake detection 100 comprises a pre-processing unit 101, a deepfake detector 102, a combination module 103 and an information overlay unit 104. The pre-processing unit 101 receives a stored audio waveform xϵ [symbol] ⁿ as input, which should be verified for authenticity by the audio deep fake detection, as input. The audio waveform xϵ [symbol] ⁿ may be any kind of data representing an audio waveform such as a piece of music, a speech of a person, or a sound like a gunshot or a car motor. The stored audio waveform can for example be represented as a vector of samples of an audio file of sample length n, or a bitstream. It may be represented by a non-compressed audio file (e.g. a wave file WAV) or a compressed audio stream such as an MP3, AAC, FLAC, WMV or the like (in which audio decompression is applied in order to obtain uncompressed audio).

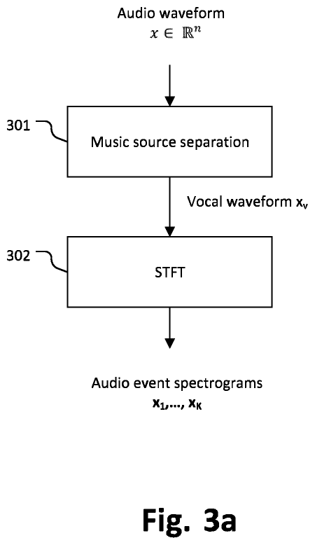

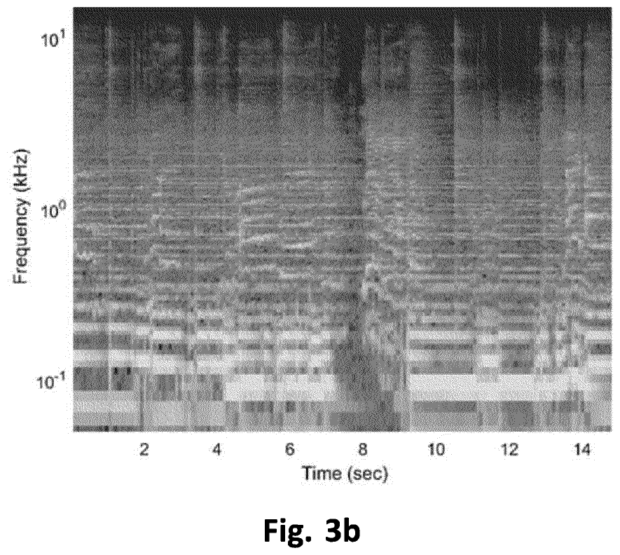

The audio pre-processing unit 101 pre-processes the complete audio waveform xϵ [symbol] ⁿ or parts or the audio waveform xϵ [symbol] ⁿ in order to detect and output multiple audio events x₁, . . . , x_{K}, with Kϵ [symbol] . This pre-processing 101 may for example comprise applying a short time Fourier transform (STFT) to parts or the complete audio waveform xϵ [symbol] ⁿ, which yield audio events x₁, . . . , x_{K} in the form of audio event spectrograms as described below in more detail with regard to FIGS. 3a, b, 5. In alternative embodiments, the audio events x₁, . . . , x_{K} are not spectrograms but represented as audio files in the same format in which the deepfake detector 102 receives audio, files. That is, the audio events x₁, . . . , x_{K} can be in the same format as the audio waveform xϵ [symbol] ⁿ or in any other audio format.

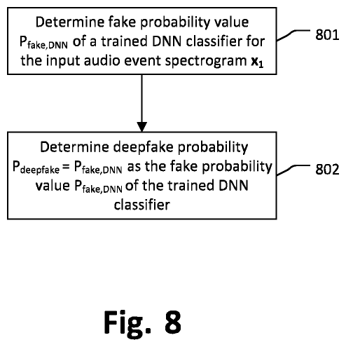

The audio events (or audio event spectrograms) x₁, . . . , x_{K} are forwarded to a deepfake detector 102, which determines deepfake probabilities P_{deepfake,1}, . . . , she might l_{deepfake,K} for the audio events (or audio event spectrograms) x₁, . . . , x_{K} which indicate a respective probability for each of the audio events (or audio event spectrograms) x₁, . . . , x_{K} of being a (computer-generated) deepfake. Embodiments of a deepfake detector are descried in more detail below with regard to FIGS. 8-14. The deepfake detector 102 outputs the deepfake probabilities P_{deepfake,1} . . . P_{deepfake,K} into a combination unit 103. The combination unit 103 combines the deepfake probabilities P_{deepfake,1}, . . . , P_{deepfake,K} and derives from the combination of the deepfake probabilities P_{deepfake,1}, . . . , P_{deepfake,K} an overall deepfake probability P_{deepfake,overall} of the audio waveform xϵ [symbol] ⁿ being a deepfake. An embodiment of the combination unit 103 is described in more detail below.

The overall deepfake probability P_{deepfake,overall} of the audio waveform xϵ [symbol] ⁿ is output form the combination unit 103 and input into a information overlay unit 104. The information overlay unit 104 further receives the audio waveform xϵ [symbol] ⁿ as input and, if the overall deepfake probability P_{deepfake,overall} of the audio waveform xϵ [symbol] ⁿ indicates that the audio waveform xϵ [symbol] ⁿ is a deepfake, the information overlay unit 104 adds (overlays) a warning message to the audio waveform xϵ [symbol] ⁿ, which yields a modified audio waveform x′ϵ [symbol] ⁿ. The warning message of the modified audio waveform x′ϵ [symbol] ⁿ can be played before or during the audio waveform xϵ [symbol] ⁿ is played to the listener to warn the listener that the audio waveform xϵ [symbol] ⁿ might be a deepfake. In another embodiment the audio waveform xϵ [symbol] ⁿ is directly played by the information overlay unit and if the overall deepfake probability P_{deepfake,overall} of the audio waveform xϵ [symbol] ⁿ is above a predetermined threshold, for example 0.5, a warning light at the smart loudspeaker system for audio deep fake detection 100 is turned on. In another embodiment the deep fake detector smart loudspeaker system 100 may constantly display a warning or trust level of the currently played part of the audio waveform xϵ [symbol] ⁿ at a screen display to the user, wherein the warning or trust level is based on the deepfake probabilities P_{deepfake,1}, . . . , P_{deepfake,K} and/or the overall deepfake probability P_{deepfake,overall} of the audio waveform xϵ [symbol] ⁿ. The information overlay unit 104 is described in more detail below.

The smart loudspeaker system for audio deep fake detection 100 as shown in FIG. 1 is able to detect audio deepfakes and output an audio or visual warning to the user, which can prevent people from believing or trusting a faked audio (or video) file.

In a first embodiment, the smart loudspeaker system for audio deepfake detection 100 may analyse the audio waveform xϵ [symbol] ⁿ in advance, i.e. before it is played out, i.e. the audio waveform xϵ [symbol] ⁿ is a stored audio waveform xϵ [symbol] ⁿ. This can be described as an off-line operational mode. In another embodiment the smart loudspeaker system for audio deep fake detection 100 may verify an audio waveform xϵ [symbol] ⁿ while it is played out, which can be described as on-line operational mode. In this case the pre-processing unit 101 receives the currently played part of an audio waveform xϵ [symbol] ⁿ as an input stream, which should be verified for authenticity. The audio pre-processing unit 101 may buffer the currently played parts of the audio waveform xϵ [symbol] ⁿ for a predetermined time span, for example 1 second or 5 seconds or 10 seconds, an then pre-process this buffered part xϵ [symbol] ⁿ of the audio stream.

The deepfake detection as described in the embodiment of FIG. 1 may be implemented directly into a smart loudspeaker system. Instead of being integrated directly into the loudspeaker, the deepfake detection processing could also be integrated into an audio player (Walkman, smartphone), or into an operating system of a PC, laptop, tablet, or smartphone.

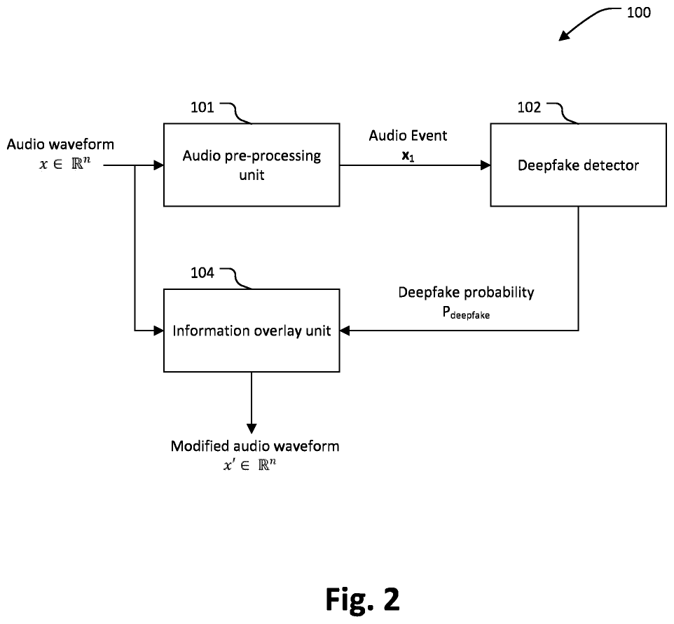

FIG. 2 shows schematically a second embodiment of a smart loudspeaker system for audio deep fake detection 100. The smart loudspeaker system for audio deep fake detection 100 of FIG. 2 comprises a pre-processing unit 101, a deepfake detector 102 and an information overlay unit 104. The audio pre-processing unit 101 determines at least one audio event x₁ based on an audio waveform x. The pre-processing unit 101 either receives the currently played part of an audio waveform xϵ [symbol] ⁿ as input (i.e. on-line operational mode) or it receives the complete in audio waveform xϵ [symbol] ⁿ as input, which should be verified for authenticity. If the pre-processing unit 101 receives a currently played audio as input, it may buffer the currently played parts of the audio waveform xϵ [symbol] ⁿ for a predetermined time span and pre-process the buffered input. In the following the buffered part will also be denoted as audio waveform xϵ [symbol] ⁿ. The audio pre-processing unit 101 pre-processes the audio waveform xϵ [symbol] ⁿ and outputs one event x₁. The event x₁ can be an audio file, for example the same format as the audio waveform xϵ [symbol] ⁿ, or can be a spectrogram such as described with regard to FIG. 1 above. The audio event (or audio event spectrogram) x₁ is then forwarded to a deepfake detector 102, which determines a deepfake probability P_{deepfake} of the audio event spectrogram x₁. An embodiment of this process is described in more detail with regard to FIGS. 8-14 below. The deepfake detector 102 outputs the deepfake probability P_{deepfake} of the audio event x₁ into the information overlay unit 104. The information overlay unit 104 further receives the audio waveform xϵ [symbol] ⁿ as input and if the deepfake probability P_{deepfake} indicates that the audio waveform xϵ [symbol] ⁿ is presumably an deepfake, the information overlay unit 104 adds (overlays) a warning message to the audio waveform xϵ [symbol] ⁿ, which yields a modified audio waveform x′ϵ [symbol] ⁿ.

FIG. 3a shows a first embodiment of the pre-processing unit 101 which is based on the principle of music source separation. If, for example, the audio waveform xϵ [symbol] ⁿ is a piece of music, it might be the case that the vocals have been altered/deepfaked or that any instrument has been altered/deepfaked. Therefore, the different instruments (tracks) are separated in order to focus on one specific track.

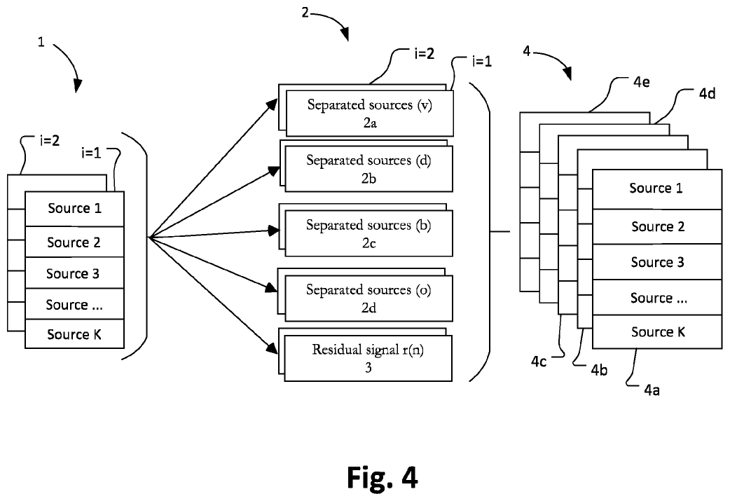

A music source separation 301 receives the audio waveform xϵ [symbol] ⁿ as input. In this embodiment the audio waveform xϵ [symbol] ⁿ is a piece of music. The music source separation separates the received audio waveform xϵ [symbol] ⁿ according to predetermined conditions. In this embodiment the predetermined condition is to separate a vocal track xᵥ from the rest of the audio waveform xϵ [symbol] ⁿ. The music source separation unit 301 (which may also perform upmixing) is described in more detail in FIG. 4. The vocal track xᵥ is then input into a STFT 302. The STFT 302 divides the vocal track xᵥ into K equal-length vocal track frames x_{v,1}, . . . , x_{v,K}, of a predetermined length, for example 1 second. To each frame of these K vocal track frames x_{v,1}, . . . , x_{v,K} a short time Fourier transform is applied which yields K audio event spectrograms x₁ . . . , x_{K}. The K frames on which the STFT 302 operates may be overlapping or not overlapping.

The short-time Fourier transform STFT is a technique to represent the change in the frequency spectrum of a signal over time. While the Fourier transform as such does not provide information about the change of the spectrum over time, the STFT is also suitable for signals whose frequency characteristics change over time. To realize the short-time Fourier transform STFT, the time signal is divided into individual time segments with the help of a window function (w) and these individual time segments are Fourier transformed into individual spectral ranges.

The input into the STFT in this embodiment are each of the vocal track frames x_{v,1}, . . . , x_{v,K}, which are time discrete entities. Therefore, a discrete-time short time Fourier transform STFT is applied. In the following the application of the STFT to the first vocal track frame x_{v,1} is described (l is the index to traverse the vector x). The STFT of the first vocal track frame x_{v,1}, using the window function w[l−m], yields a complex valued function X(m, ω), i.e. the phase and magnitude, at every discrete time step m and frequency to:

$$X ( m , ω ) := STFT \{ {x}_{v , q} [ l ] \} ( m , ω ) = {\sum }_{l = - ∞}^{∞} {x}_{v , 1} [ l ] w [ l - m ] {e}^{- j ω l}$$

The window function w[l−m] is centred around the time step m and only has values unequal to 0 for a selected window length (typically between 25 ms and 1 second). A common window function is the rectangle function.

The squared magnitude |X(m, ω)|² of the discrete-time short time Fourier transform X(m, ω) yields the audio event spectrogram x₁ of the first vocal track frame x_{v,1}:

x₁:=x₁(m,ω):=|X(m,ω)|²=|STFT{x[l]}(m,ω)|²

The audio event spectrogram x₁(m, ω) (in the following just denoted as x₁) provides a scalar value for every discrete time step m and frequency ω and may be visually represented in a density plot as a grey-scale value. That means the audio event spectrogram x₁ may be stored, processed and displayed as a grey scale image. An example of an audio spectrogram is given in FIG. 3b.

The STFT technique as described above may be applied to the complete vocal track xᵥ or to the audio waveform xϵ [symbol] ⁿ.

The width of the window function w[m] determines the temporal resolution. It is important to note, that due to the Küpfmüller uncertainty relation the resolution in the time domain and the resolution in the frequency domain cannot be chosen arbitrarily fine but are bounded by product of time and frequency which is a constant value. If the highest possible resolution in the time domain is required, for example to determine the point in time when a certain signal starts or stops, this results in a blurred resolution in the frequency domain. If a high resolution in the frequency domain is necessary to determine the frequency exactly, then this results in a blur in the time domain, i.e. the exact points in time can only be determined blurred.

The shift of the window determines the resolution of the x-axes of the resulting spectrogram. The y-axis of the spectrogram shows the frequency. Thereby the frequency may be expressed in Hz or in the mel scale. The color of each point in the spectrogram is indicating the amplitude of a particular frequency at a particular time.

In this case the parameters may be chosen accordingly to the scientific paper “CNN architectures for large-scale audio classification”, by Hershey, Shawn, et al., published in 2017 IEEE international conference on acoustics, speech and signal processing (ICASSP). IEEE, 2017. That is the vocal track xᵥ is divided into frames with a length of 960 ms. The windows have a length of 25 ms and are applied every 10 ms. The resulting spectrogram is integrated into 64 mel-spaced frequency bins. This results in spectrograms with a resolution of 96×64 pixels. A vocal track xᵥ with a length 4 minutes 48 seconds of yields 300 spectrograms each with a resolution of 96×64 pixels.

In another embodiment the predetermined conditions for the music source separation may be to separate the audio waveform xϵ [symbol] ⁿ into melodic/harmonic tracks and percussion tracks, or in another embodiment the predetermined conditions for the music source separation may be to separate the audio waveform xϵ [symbol] ⁿ into all different instruments like drums, strings and piano etc.

In another embodiment more than one track or another separated track than the vocal track xᵥ may be input into the STFT unit 302.

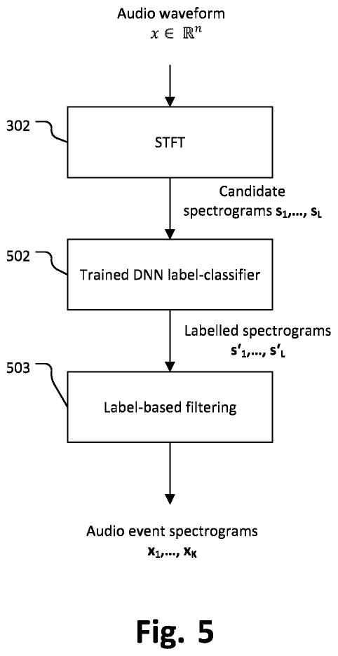

In yet another embodiment the audio event spectrograms, which are output by the STFT 302, may be further analysed by an audio event detection unit as it is describe below in more detail at FIG. 5.

FIG. 4 schematically shows a general approach of audio source separation (also called upmixing/remixing) by means of blind source separation (BSS), such as music source separation (MSS). First, audio source separation (also called “demixing”) is performed which decomposes a source audio signal 1, here audio waveform x, comprising multiple channels I and audio from multiple audio sources Source 1, Source 2, . . . , Source K (e.g. instruments, voice, etc.) into “separations”, here separated source 2, e.g. vocals xᵥ, and a residual signal 3, e.g. accompaniment s_{A}(n), for each channel i, wherein K is an integer number and denotes the number of audio sources. The residual signal here is the signal obtained after separating the vocals from the audio input signal. That is, the residual signal is the “rest” audio signal after removing the vocals for the input audio signal. In the embodiment here, the source audio signal 1 is a stereo signal having two channels i=1 and i=2. Subsequently, the separated source 2 and the residual signal 3 are remixed and rendered to a new loudspeaker signal 4, here a signal comprising five channels 4a-4e, namely a 5.0 channel system. The audio source separation process (see 104 in FIG. 1) may for example be implemented as described in more detail in published paper Uhlich, Stefan, et al. “Improving music source separation based on deep neural networks through data augmentation and network blending.” 2017 IEEE International Conference on Acoustics, Speech and Signal Processing (ICASSP). IEEE, 2017.

As the separation of the audio source signal may be imperfect, for example, due to the mixing of the audio sources, a residual signal 3 (r(n)) is generated in addition to the separated audio source signals 2a-2d. The residual signal may for example represent a difference between the input audio content and the sum of all separated audio source signals. The audio signal emitted by each audio source is represented in the input audio content 1 by its respective recorded sound waves. For input audio content having more than one audio channel, such as stereo or surround sound input audio content, also a spatial information for the audio sources is typically included or represented by the input audio content, e.g. by the proportion of the audio source signal included in the different audio channels. The separation of the input audio content 1 into separated audio source signals 2a-2d and a residual 3 is performed on the basis of blind source separation or other techniques which are able to separate audio sources. The audio source separation may end here, and the separated sources may be output for further processing.

In another embodiment two or more separations may be mixed together again (e.g., if the network has separated the noisy speech into “dry speech” and “speech reverb”) in a second (upmixing) step. In a second step, the separations 2a-2d and the possible residual 3 are remixed and rendered to a new loudspeaker signal 4, here a signal comprising five channels 4a-4e, namely a 5.0 channel system. On the basis of the separated audio source signals and the residual signal, an output audio content is generated by mixing the separated audio source signals and the residual signal on the basis of spatial information. The output audio content is exemplary illustrated and denoted with reference number 4 in FIG. 4.

### Audio Event Detection

FIG. 5 shows a second embodiment of the pre-processing unit 101. In this embodiment the pre-processing unit 101 comprises a STFT 302, as described above in FIG. 3 and a trained DNN label-classifier 502 and a label-based filtering 503. The STFT 302 an especially the training as well as the operation of the trained DNN label-classifier 502 are described in more detail in the scientific paper “CNN architectures for large-scale audio classification”, by Hershey, Shawn, et al., published in 2017 IEEE international conference on acoustics, speech and signal processing (ICASSP). IEEE, 2017.

The STFT unit 302 receives the audio waveform xϵ [symbol] ⁿ as input. The STFT 302 unit divides the receiving audio waveform xϵ [symbol] ⁿ into L equal-length frames, of a predetermined length. As described in the scientific paper quoted above the STFT 302, divides the receiving audio waveform xϵ [symbol] ⁿ in into frames with a length of 960 ms. The windows have a length of 25 ms and are applied every 10 ms. The resulting spectrogram is integrated into 64 mel-spaced frequency bins. This results in spectrograms with a resolution of 96×64 pixels. To these L frames a short time Fourier transform is applied which yields candidate spectrograms s₁, . . . , s_{L}. The candidate spectrograms s₁, . . . , s_{L} are input into the trained DNN label-classifier 501. The trained DNN label-classifier 501 comprises a trained deep neural network, which is trained as described in the scientific paper quoted above. That is, the DNN is trained to label the input spectrograms in a supervised manner (i.e. using labelled spectrograms during the learning process), wherein 30871 labels are used from the “google knowledge graph” database, for example labels like “song”, “gunshot”, or “President Donald J. Trump”. In the operational mode the trained DNN label-classifier outputs the candidate spectrograms s₁, . . . , s_{L} each provided with one or more labels (from the 30871 labels from the “google knowledge graph” database), which yields the set of labelled spectrograms s′₁, . . . , s′_{L}. The set of labelled spectrograms s′₁, . . . , s′_{L} is input into the label-based filtering 503, which only lets spectrograms from the set of spectrograms s′₁, . . . s′_{L} pass, which are part of a predetermined pass-set. The predetermined pass-set may for example include labels like “human speech” or “gunshot”, or “speech of President Donald J. Trump”. The subset of the K spectrograms of set of labelled spectrograms s′₁, . . . , s′_{L}, which are allowed to pass the label-based filtering 503, are defined as audio event spectrograms x₁, . . . , x_{K} (wherein the labels may be removed or not).

### Deepfake Detector Comprising a DNN Classifier

In one embodiment the deepfake detector 102 comprises a trained deep neural network (DNN) classifier, for example a convolutional neuronal network (CNN), that is trained to detect audio deepfakes. In the case that the audio event spectrograms x₁, . . . , x_{K} as output by pre-processing unit 101 are spectrograms, i.e. images (e.g. grayscale or two-channel), the deepfake detector can utilizes neural network methods and techniques which were developed to detect video/image deepfakes.

In one embodiment the deepfake detector 602 comprises one of the several different methods of deepfake image detection which are described in the scientific paper “DeepFakes and Beyond: A Survey of Face Manipulation and Fake Detection”, by Tolosana, Ruben, et al. published in arXiv preprint arXiv:2001.00179 (2020).

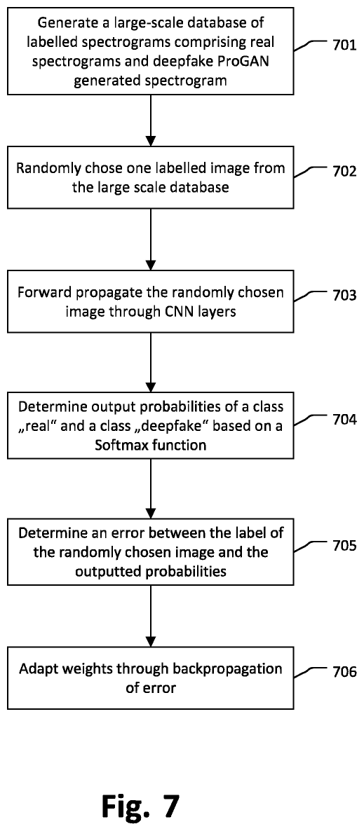

In another embodiment the deepfake detector comprises a DNN classifier as described in the scientific paper “CNN-generated images are surprisingly easy to spot . . . for now”, by Wang, Sheng-Yu, et al. published in arXiv preprint arXiv:1912.11035 (2019). In this embodiment convolutional neuronal networks (CNN) are used, which are a common architecture to implement DNNs for images. The training of the deepfake detector 102 for this embodiment is described in more detail in FIG. 7 below and the operational mode of the deepfake detector 102 for this embodiment is described in more detail in FIG. 8.

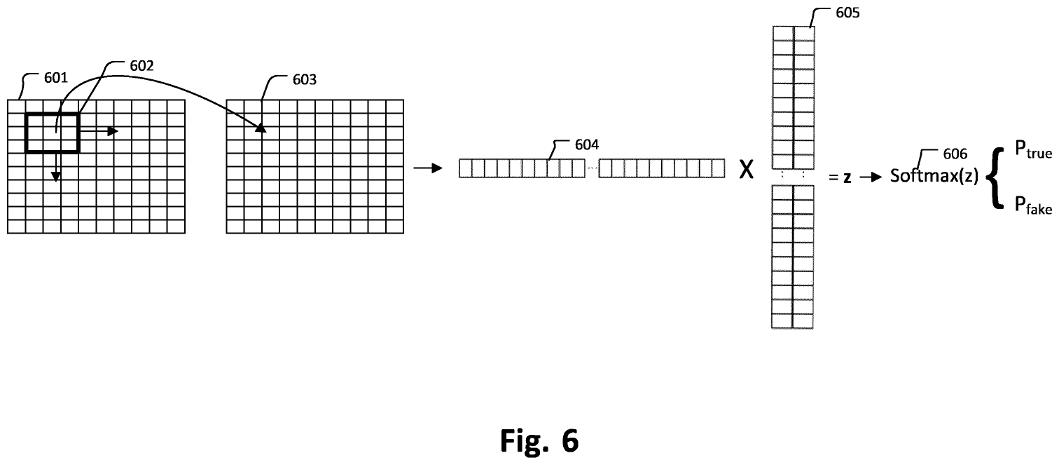

The general architecture of a CNN for image classification is described below in FIG. 6 In another embodiment the audio events x₁, . . . , x_{K} as output by pre-processing unit 101 are audio files and the deepfake detector 102 is directly trained to distinguish audio files and is able to detect deepfakes in the audio file audio events x₁, . . . , x_{K}.

FIG. 6 schematically shows the architecture of a CNN for image classification. An input image matrix 601 is input into the CNN, wherein each entry of the input image matrix 601 corresponds to one pixel of an image (for example a spectrogram), which should be processed by the CNN.

The value of each entry of the input image matrix 601 is the value of the colour of each pixel. For example, each entry of the input image matrix 601 might be a 24-bit value, wherein each of the colours red, green, and blue occupies 8 bits. A filter (also called kernel or feature detector) 602, which is a matrix (may be symmetric or asymmetric; in audio applications, it may be advantageous to use asymmetric kernels as the audio waveform—and therefore also the spectrogram—may be not symmetric). with an uneven number of rows and columns (for example 3×3, 5×5, 7×7 etc.), is shifted from left to right and top to bottom such that the filter 602 is once centred over every pixel. At every shift the entries of the filter 602 are elementwise multiplied with the corresponding entries in the image matrix 601 and the result of all elementwise multiplication are summed up. The result of the summation generates the entry of a first layer matrix 603 which has the same dimension as the input image matrix 601. The position of the centre of the filter 602 in the input image matrix 601 is the same position where the generated result of the multiplication-summation as described above is placed in the first layer matrix 603. All rows of the first layer matrix 603 are placed next to each other to form a first layer vector 604. A nonlinearity (e.g., ReLU) may be placed between the first layer matrix 603 (convolutional layer) and the first layer vector 604 (affine layer). The first layer vector 604 is multiplied with a last layer matrix 605, which yields the result z. The last layer matrix 605 has as many rows as the first layer vector has columns and the number of S columns of the last layer vector corresponds to the S different classes into which the CNN should classify the input image matrix 601. For example, S=2, i.e. the image corresponding to the input image matrix 601 should be classified as either fake or real. The result z of the matrix multiplication between the first layer vector 604 and the last layer matrix 605 is input into a Softmax function. The Softmax function is defined as

$${σ ( z )}_{i} = \frac{{e}^{{z}_{i}}}{{\sum }_{j = 1}^{S} {e}^{{z}_{j}}}$$

with i=1, . . . , S, which yields a probability distribution over the S classes, i.e. the probability for each of the S different classes into which the CNN should classify the input image matrix 601, which is in this case the probability Pᵣₑₐₗ that the input image matrix 601 corresponds to a real image and the probability P_{fake} that the input image matrix 601 corresponds to a deepfake image. For binary classification problems, i.e. S=2, only one output neuron with a sigmoid nonlinearity may be used and if the output is below 0.5 the input may be labeled as class 1 and if it is above 0.5 the input may be labeled as class 2.

The entries of the filter 602 and the entries of the of the last layer matrix 605 are the weights of the CNN which are trained during the training process (see FIG. 7).

The CNN can be trained in a supervised manner, by feeding an input image matrix, which is labelled as either corresponding to a real image or a fake image, into the CNN. The current output of the CNN, i.e. the probability of the image being real or fake is input into a loss function and through a backpropagating algorithm the weights of the CNN are adapted.

The probability P_{fake} that an input image is a classified as a deepfake by the trained classifier is also denoted as the fake probability value of a trained DNN classifier P_{fake,DNN} i.e. P_{fake,DNN}=P_{fake}.

There exist several variants of the general CNN architecture described above. For example, multiple filters in one layer can be used and/or multiple layers can be used.

As described above in one embodiment the deepfake detector uses the DNN classifier as described in the scientific paper “CNN-generated images are surprisingly easy to spot . . . for now”, by Wang, Sheng-Yu, et al. published in arXiv preprint arXiv:1912.11035 (2019). In this case the Resnet 50 CNN pretrained with ImageNet is used in a binary classification setting (i.e. the spectrogram is real of fake). The training process of this CNN is described in more detail in FIG. 7.

FIG. 7 shows a flowchart of a training process of a DNN classifier in the deepfake detector 102. In step 701, a large-scale database of labelled spectrograms is generated comprising real spectrograms and deepfake spectrograms, which were for example generated with a Generative Adversarial Network like ProGAN, as it is for example described in the scientific paper “Progressive growing of GANs for improved quality, stability, and variation”, by Tero Karras, Timo Aila, Samuli Laine, and Jaakko Lehtinen, published in ICLR, 2018. In step 702, one labelled image from the large-scale database is randomly chosen. In step 703, the randomly chosen image is forward propagated through the CNN layers. In step 704, output probabilities of class “real” and a class “deepfake” are determined based on a Softmax function. In step 705, an error is determined between the label of the randomly chosen image and the outputted probabilities. In step 706, the error is backpropagated to adapt the weights. Steps 702 to 706 are repeated for several times to properly train the network.

Many deepfakes are generated with Generative Adversarial Networks (GANs). GANs consist of two artificial neural networks that perform a zero-sum game. One of them creates candidates (the generator), the second neural network evaluates the candidates (the discriminator). Typically, the generator maps from a vector of latent variables to the desired resulting space. The goal of the generator is to learn to produce results according to a certain distribution. The discriminator, on the other hand, is trained to distinguish the results of the generator from the data of the real, given distribution. The objective function of the generator is then to produce results that the discriminator cannot distinguish. In this way, the generated distribution should gradually adjust to the real distribution. There exists many different implementations and architectures of GANs.

As described in the above quoted scientific paper although the CNN in the deepfake detector 102 is only trained with deepfake spectrograms generated with one artificial intelligence techniques, for example the GAN architecture ProGAN, it is able to detect deepfake spectrograms generated from several different models.

In another embodiment the CNN in the deepfake detector 102 may be trained with deepfakes which are generated with another model than with ProGAN, or the CNN in the deepfake detector 102 may be trained with deepfakes which are generated with several different models.

In another embodiment the deepfake spectrograms of the large-scale database used for training of a DNN deepfake classifier may be generated by applying audio-changing artificial intelligence techniques directly to audio files and then transforming them by means of STFT into a deepfake spectrogram.

The error may be determined by calculating the error between the probability output by the Softmax function and the label of the image. For example if the image was labelled “real” and the probability output of the Softmax function for being real is Pᵣₑₐₗ and for being a deepfake is P_{fake} then the error may be determined as

$$error = \frac{1}{2} [ {( 1 - {P}_{real} )}^{2} + {( 0 - {P}_{fake} )}^{2} ] .$$

Through backpropagation, for example with a gradient descent method, the weights are adapted based on the error. The probability P_{fake} that an input image is classified as a deepfake by the trained classifier is also denoted as the output value of the trained DNN classifier P_{DNN}, i.e. P_{DNN}=P_{fake}.

FIG. 8 shows the operational mode of a deepfake detector 102 comprising a trained DNN classifier. In step 801, a fake probability value P_{fake,DNN} of a trained DNN classifier for the input audio event spectrogram x₁ of being a deepfake is determined. The input spectrogram (i.e. the input audio event spectrogram x₁) can either be a real spectrogram or a deepfake spectrogram, which was generated with an arbitrary generation method, for example with any GAN architecture or with a DNN. In step 802, a deepfake probability P_{deepfake}=P_{fake,DNN} is determined as the fake probability value P_{fake,DNN} of a trained DNN classifier.

If more than one audio event spectrogram is input into the deepfake detector 102 comprising a trained DNN classifier the same process as described in FIG. 8 is applied to every audio event spectrogram x₁, . . . , x_{K} and the deepfake probability P_{deepfake} for the respective input audio event spectrogram x₁, . . . , x_{K} will be denoted as P_{deepfake,1}, . . . , P_{deepfake,K}.

### Deepfake Detector Comprising Other Detection Methods

The problem of detecting a deepfake may be considered from generator-discriminator perspective (GANs). That means that a generator tries to generate deepfakes and a discriminator, i.e. the deepfake detector 102 comprising a DNN classifier as described above, tries to identify the deepfakes. Therefore, it may happen that an even more powerful generator might eventually fool the discriminator (for example after being trained for enough epochs), i.e. the deepfake detector 102 comprising a DNN classifier as described above. Therefore, the deepfake detector 102 comprising a DNN classifier as described above might be extended by different deepfake detection methods.

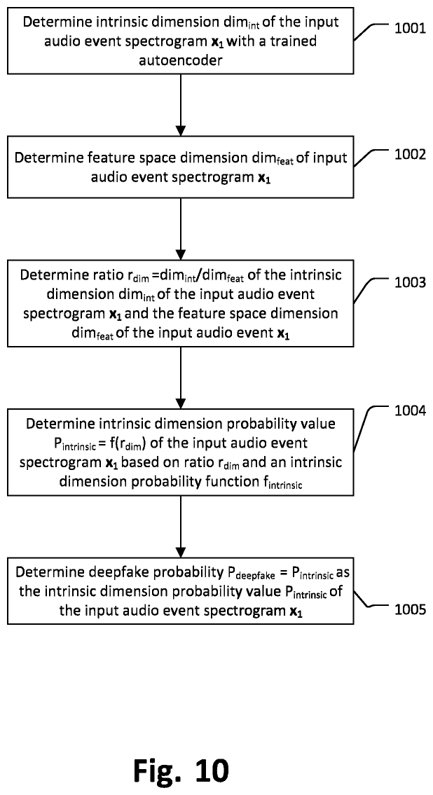

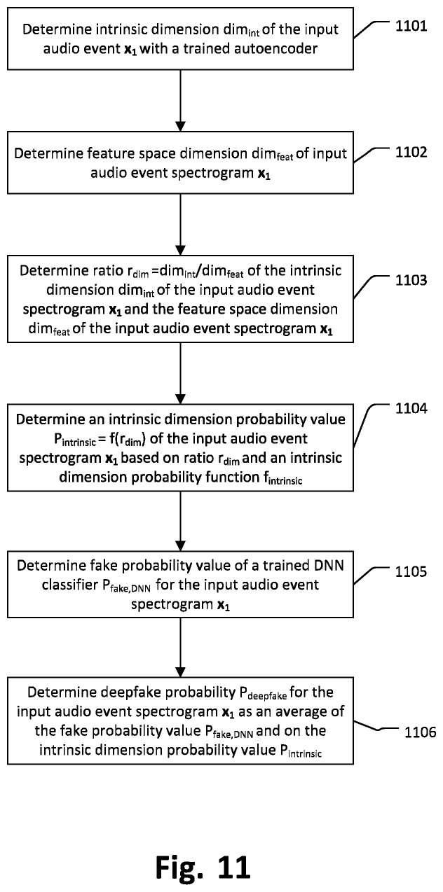

Still further in another embodiment the deepfake detector 102 comprises additionally to the DNN classifier as described above or instead of the DNN classifier as describe above an estimation of an intrinsic dimension of the audio waveform xϵ [symbol] ⁿ (see FIGS. 10-11).

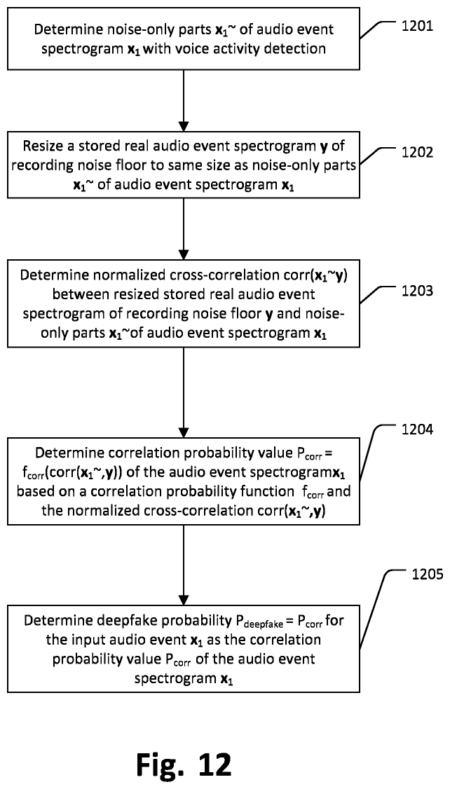

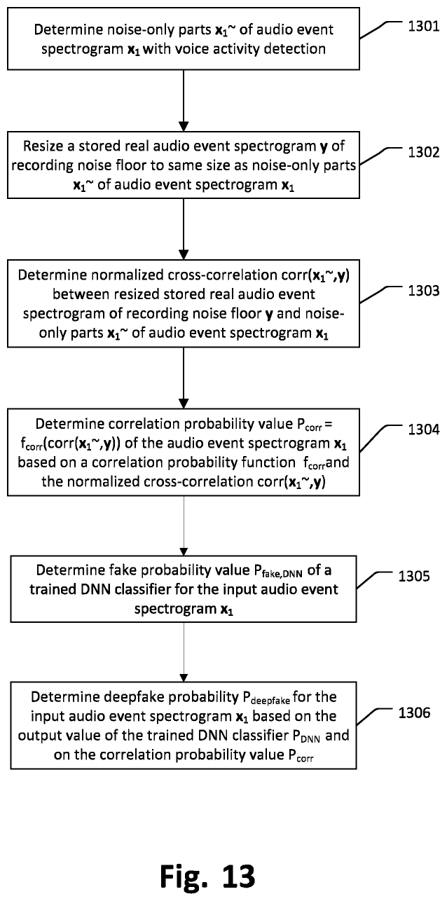

Still further in another embodiment the deepfake detector 102 comprises additionally to the DNN classifier as described above or instead of the DNN classifier as describe above a disparity discriminator (see FIGS. 12-13).

### Intrinsic Dimension Estimator

The intrinsic dimension (also called inherent dimensionality) of a data vector v (for example an audio waveform or an audio event) is the minimal number of latent variables needed to describe (represent) the data vector v (see details below).

This concept of the intrinsic dimension, with an even broader definition based on a manifold dimension where the intrinsic dimension does only need to exist locally, is also described in the textbook “Nonlinear Dimensionality Reduction” by Lee, John A., Verleysen, Michel, published in 2007.

Usually, real world datasets, for example a real-world image, have large numbers of (data) factors, often significantly greater than the number of latent factors underlying the data generating process. Therefore, the ratio between the number of features of a real dataset (for example a real spectrogram) and its intrinsic dimension can be significantly higher than then ratio between the number of features of deepfake dataset (for example a deepfake spectrogram) and its intrinsic dimension.

The estimation of an intrinsic dimension of an image (for example a spectrogram) is described in the scientific paper “Dimension Estimation Using Autoencoders”, by Bahadur, Nitish, and Randy Paffenroth, published on arXiv preprint arXiv:1909.10702 (2019). In this scientific paper an autoencoder is trained to estimate the intrinsic dimension of an input image.

An autoencoder is a type of artificial neural network used to learn efficient data codings in an unsupervised manner. The aim of an autoencoder is to learn a (latent) representation (encoding) for a set of data by training the network to ignore signal “noise”. Along with the reduction side (encoder), a reconstructing side (decoder) is learnt, where the autoencoder tries to generate from the reduced encoding a representation as close as possible to its original input, hence its name. One variant of an autoencoder is a feedforward, non-recurrent neural network similar to single layer perceptrons that participate in multilayer perceptrons (MLP)—having an input layer, an output layer and one or more hidden layers connecting them—where the output layer has the same number of nodes (neurons) as the input layer, and with the purpose of reconstructing its inputs (minimizing the difference between the input and the output) instead of predicting the target value Y given inputs X. Therefore, autoencoders are unsupervised learning models (do not require labelled inputs to enable learning).

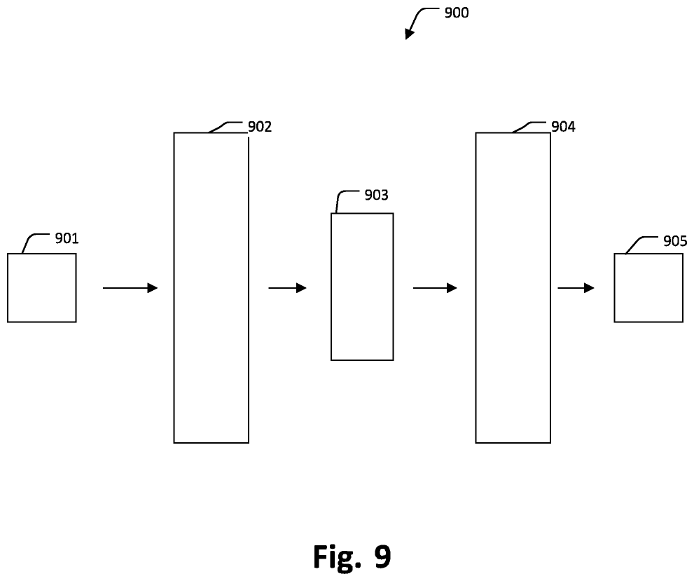

FIG. 9 schematically shows an autoencoder 900. An input image 901 is input into input layer of the encoder 902 and propagated through the layers of the encoder 902 and output into the hidden layer 903 (also called latent space). A latent representation is output from the hidden layer 903 into an input layer of a decoder 904 and propagated through layers of the decoder 904 and output by an output layer of the decoder 904. The output of the decoder 904 is an output image 905, which has the same dimension (numbers of pixels) as the input image 905.

A latent space dimension is defined as the number of nodes in the hidden layer (latent space) in an autoencoder.

A feature space dimension is defined as the number of input nodes in the input layer in an encoder of an autoencoder, for example number of pixels of a spectrogram.

In the training mode, the autoencoder 900 is trained with different deepfake spectrograms and real spectrograms and learns a latent representation of the input deepfake spectrograms and real spectrograms. From this latent representation of the input spectrograms the intrinsic dimension of the input image can be estimate as described in scientific paper “Dimension Estimation Using Autoencoders”, by Bahadur, Nitish, and Randy Paffenroth, published on arXiv preprint arXiv:1909.10702 (2019).

In operational mode the trained autoencoder 900 outputs an estimated intrinsic dimension dimᵢₙₜ of an input spectrogram.

FIG. 10 shows an operational mode of a deepfake detector 102 comprising an intrinsic dimension estimator. In step 1001, an intrinsic dimension dimᵢₙₜ of the input audio event spectrogram x₁ is determined with the trained autoencoder 900. In step 1002, a feature space dimension dim_{feat} of the input audio event spectrogram x₁ is determined as a number of pixels of input audio event spectrogram x₁. As described in FIG. 5 the audio event spectrogram x₁ can for example have a resolution of 96×64 pixels which yields a feature space dimension dim_{feat}=6114. In step 1003, the ratio

$${r}_{dim} = \frac{{dim}_{int}}{{dim}_{feat}}$$

of the intrinsic dimension dimᵢₙₜ of the input audio event spectrogram x₁ and feature space dimension dim_{feat} of the input audio event spectrogram x₁ is determined. In step 1004, an intrinsic dimension probability value P_{intrinsic}−ƒ_{intrinsic}(r_{dim}) of the input audio event spectrogram x₁ is determined based on the ratio r_{dim} of the intrinsic dimension dimᵢₙₜ and the an intrinsic dimension probability function ƒ_{intrinsic}. In step 1005, a deepfake probability P_{deepfake}=P_{intrinsic} is determined as the intrinsic dimension probability value P_{intrinsic}.

The intrinsic dimension probability function ƒ_{intrinsic} may be a piecewise-defined function, which may be defined as:

$${f}_{intrinsic} ( {r}_{dim} ) = \{ \begin{matrix}0.1 + 0.9 * {r}_{dim} , & for {r}_{dim} ∈ [ 0 , 1 , 1 ] \\ 1 , & for {r}_{dim} > 1 \\ 0 , & for {r}_{dim} < 0.1\end{matrix}$$

If more than one audio event spectrogram is input into the deepfake detector 102 comprising an intrinsic dimension estimator, the same process as described in FIG. 10 is applied to every audio event spectrogram.

FIG. 11 shows a deepfake detector 102, which comprises an DNN deepfake classifier and an intrinsic dimension estimator. In step 1101, an intrinsic dimension dimᵢₙₜ of the input audio event spectrogram x₁ is determined with the trained autoencoder 900. In step 1002, a feature space dimension dim_{feat} of the input audio event spectrogram x₁ is determined as a number of pixels of input audio event spectrogram x₁. In step 1103, the ratio

$${r}_{dim} = \frac{{dim}_{int}}{{dim}_{feat}}$$

of the intrinsic dimension dimᵢₙₜ of the input audio event spectrogram x₁ and feature space dimension dim_{feat} of the input audio event spectrogram x₁ is determined. In step 1104, an intrinsic dimension probability value P_{intrinsic}−ƒ_{intrinsic}(r_{dim}) of the input audio event spectrogram x₁ is determined based on the ratio r_{dim} of the intrinsic dimension dimᵢₙₜ and the an intrinsic dimension probability function ƒ_{intrinsic}. In step 1105, a fake probability value P_{fake,DNN} of a trained DNN classifier for the input audio event spectrogram x₁ of being a deepfake is determined, as described in FIGS. 7-8. In step 1106, a deepfake probability P_{deepfake} for the input audio event spectrogram x₁ is determined as an average of the intrinsic dimension probability value P_{intrinsic} and the fake probability value P_{fake,DNN} of the trained DNN classifier:

$${P}_{deepfake} = \frac{{P}_{fake , DNN} + {P}_{intrinsic}}{2} .$$

In another embodiment, deepfake probability P_{deepfake} for the input audio event spectrogram x₁ is determined as the maximum of the intrinsic dimension probability value P_{intrinsic} and the fake probability value P_{fake,DNN} of the trained DNN classifier: P_{deepfake}=max{P_{fake,DNN}, P_{intrinsic}}.

If more than one audio event spectrogram is input into the deepfake detector 102 comprising a DNN deepfake classifier and an intrinsic dimension estimator, the same process as described in FIG. 11 is applied to every audio every audio event spectrogram x₁, . . . , x_{K} and the deepfake probability P_{deepfake} for the respective input audio event spectrogram x₁, . . . , x_{K} will be denoted as P_{deepfake,1}, . . . P_{deepfake,K}.

### Disparity Discriminator

The deepfake detector 102 can comprise a disparity discriminator. A disparity discriminator can discriminate a real audio event from a fake audio event by comparing pre-defined features or patterns of an input audio waveform (or an audio event) to the same pre-defined features or patterns of a stored real audio waveform. That works, because it can be observed that there are disparities for certain properties between real audio events and deepfake audio events.

In one embodiment the disparity discriminator of the audio deepfake detector 102, can discriminate between a real audio event and a deepfake audio event by comparing (for example by a correlation, see FIG. 12) (patterns of) a recording noise floor of an input audio event to a recording noise floor of a stored real audio event (or to more than one recording noise floor of a stored real audio event as described below). A piece of music, for example a song, which was recorded in a studio or another room has a (background) noise floor that is typical for the room where it is recorded. A deepfake audio waveform does often not have a recording noise floor. The recording noise floor/room noise floor is particularly noticeable during parts of piece of music, where no vocals or instruments are present, i.e. so-called noise-only parts.

FIG. 12 shows an embodiment of a deepfake detector, which comprises a disparity discriminator. In step 1201, a noise-only part \tilde{x}₁ of an audio event spectrogram x₁ is determined with a voice activity detection. That means, a part of the audio event spectrogram x₁ is cut out if a noise-only part is detected in this part. For example, a voice activity detection (VAD) that can be performed on the audio event spectrograms x₁ is described in more detail in the scientific paper “Exploring convolutional neural networks for voice activity detection”, by Silva, Diego Augusto, et al., published in Cognitive Technologies by Springer, Cham, 2017, 37-47. In step 1202, a stored real audio event spectrogram y of a recording noise floor is resized to the same size as the noise-only part \tilde{x}₁ of audio event spectrogram x₁. The resizing can for example be done by cropping or down-sampling or up-sampling of a stored real audio event spectrogram of a recording noise floor spectrogram y. In step 1203, a normalized cross-correlation corr(\tilde{x}₁, y) between the resized stored real audio event spectrogram y of the recording noise floor and the noise-only parts \tilde{x}₁ of the audio event spectrogram x₁ is determined. In step 1204, a correlation probability value P_{corr}=ƒ_{corr}(corr(\tilde{x}₁, y)) of the audio event spectrogram x₁ is determined based on a correlation probability function ƒ_{corr} and the normalized cross-correlation corr(\tilde{x}₁, y). In step 1205, a deepfake probability P_{deepfake}=P_{corr} is determined as the correlation probability value.

The correlation probability function ƒ_{corr} is defined as:

$${f}_{corr} ( corr ( {\tilde{x}}_{1} , y ) ) = \{ \begin{matrix}1 - corr ( {\tilde{x}}_{1} , y ) , & for corr ( {\tilde{x}}_{1} , y ) > 0 \\ 1 , & for corr ( {\tilde{x}}_{1} , y ) < 0\end{matrix}$$

In another embodiment the disparity discriminator of the audio deepfake detector 102, can discriminate between a real audio event and more than one recording noise floors of more than one stored real audio event (e.g., for different recording studios). In this case instead of the term corr(\tilde{x}₁, y) the term

$${max}_{y ∈ “ all recording noise floors of real audio events ”}$$

corr(\tilde{x}₁, y) is used.

In another embodiment the disparity discriminator of the audio deepfake detector 102, can discriminate between a real audio event and a deepfake audio event by comparing (for example by a correlation) (patterns of) of a quantization noise floor (also called artefacts) of an input audio event to a quantization noise floor of a stored real audio event. That is because real vocal signals are recorded with a (analog) microphone and the conversion from an analog signal to a digital signal (A/D conversion) through a quantization process results in a quantization noise floor in the real vocal signal. This quantization noise floor has a specific pattern which can be detected, for example by comparing the quantization noise floor pattern of the input waveform to quantization noise floor pattern a stored real audio waveform, for example by applying a cross-correlation as explained above to the spectrogram of the input audio event spectrogram and to a stored spectrogram of a real audio event which comprises a typical quantization noise floor. If the input audio event is a music piece the vocal track of the input audio event can be separated from the rest of the music piece (see FIG. 4) and then the cross correlation can be applied to the spectrograms. Still further, to the input audio event or to the separated vocal track a VAD can be applied as described above and the cross correlation as explained above can be applied to the spectrograms. The deepfake probability P_{deepfake} may be determined as described in the embodiment above.

Or in another embodiment an artificial neural network can be trained specifically to discriminate the disparities of the recording noise floor feature(s) and the quantization noise floor feature(s) between a real spectrogram and a deepfake spectrogram.

In yet another embodiment disparities for certain properties between real audio event spectrograms and deepfake audio event spectrograms may be visible in one or more differing features of a learned latent representation. A latent representation of a spectrogram of an audio waveform may be obtained by the use of an autoencoder, as described above in FIG. 9. That is, the autoencoder is used to extract the features of an input audio waveform, for example by dimension reduction methods as described in the scientific paper quoted above “Dimension Estimation Using Autoencoders”, by Bahadur, Nitish, and Randy Paffenroth, published on arXiv preprint arXiv:1909.10702 (2019). That means an autoencoder reduces the dimension of the features of the input data, i.e. a spectrogram of an audio waveform, to a minimum number, for example the non-zero elements in the latent space. One of these features may correspond to a recording/quantization noise in the audio waveform. This feature may have another distribution for a spectrogram of a real audio waveform compared to spectrogram of a deepfake audio waveform. The disparity discriminator may therefore detect a deepfake audio waveform when the comparison (for example a correlation) between the in-advance known distribution of a certain feature of a spectrogram of a real audio waveform and the distribution of the same feature of a spectrogram of an input audio waveform yields too little similarity. The deepfake probability P_{deepfake} may be determined as described in the embodiment above by applying a cross correlation function to the distribution of the feature of the input audio event and to the distribution of the same feature of a stored real audio event.

Still further in another embodiment the deepfake detector 102 comprises additionally to the DNN classifier as describe above in FIG. 8 a disparity discriminator: FIG. 13 shows a deepfake detector 102, which comprises an DNN deepfake classifier and a disparity discriminator. In step 1301, a noise-only part \tilde{x}₁ of an audio event spectrogram x₁ is determined with a voice activity detection. That means, a part of the audio event spectrogram x₁ is cut out if a noise-only part is detected in this part. For example, a voice activity detection (VAD) that can be performed on the audio event spectrograms x₁ is described in more detail in the scientific paper “Exploring convolutional neural networks for voice activity detection”, by Silva, Diego Augusto, et al., published in Cognitive Technologies by Springer, Cham, 2017, 37-47. In step 1302, a stored real audio event spectrogram y of a recording noise floor is resized to same size as noise-only parts \tilde{x}₁ of audio event spectrogram x₁. In step 1303, a normalized cross-correlation corr(\tilde{x}₁, y) between the resized stored real audio event spectrogram y of the recording noise floor and the noise-only parts \tilde{x}₁ of the audio event spectrogram x₁ is determined. In step 1204, a correlation probability value P_{corr}=ƒ_{corr}(corr(\tilde{x}₁, y)) of the audio event spectrogram x₁ is determined based on a correlation probability function ƒ_{corr} and the normalized cross-correlation corr(\tilde{x}₁, y). In step 1304, a fake probability value P_{fake,DNN} of a trained DNN classifier for the input audio event spectrogram x₁ is determined, as described in FIGS. 7-8. In step 1305, a deepfake probability P_{deepfake} is determined as the average of the correlation probability value P_{corr} and the fake probability value P_{fake,DNN} of a trained DNN classifier:

$${P}_{deepfake} = \frac{{P}_{fake , DNN} + {P}_{intrinsic}}{2} .$$

In another embodiment, deepfake probability P_{deepfake} for the input audio event spectrogram x₁ is determined as the maximum of the correlation probability value P_{corr} and the fake probability value P_{fake,DNN} of a trained DNN classifier: P_{deepfake}=max{P_{fake,DNN}, P_{corr}}.

If more than one audio event spectrogram is input into the deepfake detector 102 comprising a DNN deepfake classifier and an intrinsic dimension estimator, the same process as described in FIG. 13 is applied to every audio event spectrogram x₁, . . . , x_{K} and the deepfake probability P_{deepfake} for the respective input audio event spectrogram x₁, . . . , x_{K} will be denoted as P_{deepfake,1}, . . . , P_{deepfake,K}.

Still further in another embodiment the deepfake detector 102 comprises additionally to DNN classifier as describe above in FIG. 8 a disparity discriminator and an intrinsic dimension estimator:

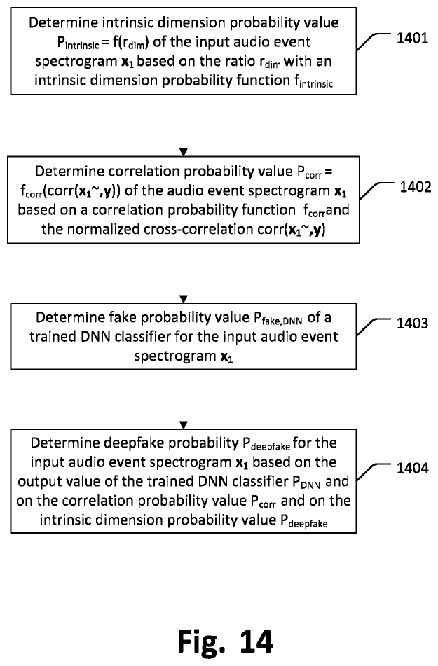

FIG. 14 shows a deepfake detector 102, which comprises a DNN deepfake classifier, a disparity discriminator and an intrinsic dimension estimator. In step 1401, an intrinsic dimension probability value P_{intrinsic}−ƒ_{intrinsic}(r_{dim}) of the input audio event spectrogram x₁ is determined based on the ratio r_{dim} of the intrinsic dimension dimᵢₙₜ and the an intrinsic dimension probability function ƒ_{intrinsic}. In step 1402, a correlation probability value P_{corr}=ƒ_{corr}(corr(\tilde{x}₁, y)) of the audio event spectrogram x₁ is determined based on a correlation probability function ƒ_{corr} and the normalized cross-correlation corr(\tilde{x}₁, y). In step 1403, a fake probability value P_{fake,DNN} of a trained DNN classifier for the input audio event spectrogram x₁ is determined, as described in FIGS. 7-8. In step 1404, a deepfake probability P_{deepfake} for the input audio event spectrogram x₁ is determined as an average of the correlation probability value P_{corr}, fake probability value P_{fake,DNN} and the intrinsic dimension probability value P_{intrinsic}:

$${P}_{deepfake} = \frac{{P}_{fake , DNN} + {P}_{corr} + {P}_{intrinsic}}{3} .$$

In another embodiment, deepfake probability P_{deepfake} for the input audio event spectrogram x₁ is determined as the maximum of the correlation probability value P_{corr} and the fake probability value P_{fake,DNN} and the intrinsic dimension probability value P_{intrinsic}: P_{deepfake}=max{P_{fake,DNN}, corr, P_{intrinsic}}.

If more than one audio event spectrogram is input into the deepfake detector 102 comprising a DNN deepfake classifier and an intrinsic dimension estimator, the same process as described in FIG. 14 is applied to every audio every audio event spectrogram x₁, . . . , x_{K} and the deepfake probability P_{deepfake} for the respective input audio event spectrogram x₁, . . . , x_{K} will be denoted as P_{deepfake,1}, . . . P_{deepfake,K}.

### Combination Unit

In the embodiment of FIG. 1 the smart loudspeaker system for audio deep fake detection 100 comprises a combination unit 103. In this embodiment the deepfake detector 102 outputs the deepfake probabilities P_{deepfake,1}, . . . , P_{deepfake,K} for the respective audio events x₁, . . . , x_{K} into the combination unit 103. The combination unit 103 combines the deepfake probabilities P_{deepfake,1}, . . . , P_{deepfake,K} for the respective audio events x₁, . . . , x_{K} into an overall deepfake probability P_{deepfake,overall} of the audio waveform x.

In one embodiment the combination unit combines them into an overall deepfake probability P_{deepfake,overall} of the audio waveform x as P_{deepfake,overall}=max{P_{deepfake,1}, . . . , P_{deepfake,K}}.

In another embodiment a refinement is taken into account by weighing the deepfake probabilities P_{deepfake,1}, . . . , P_{deepfake,K} for the respective audio events x₁, . . . , x_{K} with respective weights w₁, . . . , w_{K}>0. For example the audio events which contain speech, may be weighted higher.

The overall deepfake probability P_{deepfake,overall} of the audio waveform x is determined as P_{deepfake,overall}=Σₖ₌₁^{K}wₖPₖ/Σₖ₌₁^{K}wₖ.

The overall deepfake probability P_{deepfake,overall} of the audio waveform x is output from the combination unit 103 and input into into a information overlay unit 104.

### Information Overlay Unit

The information overlay unit 104 receives a deepfake probability of an audio file and the audio file itself and generates a warning message which is overlaid over the audio file, which yields a modified audio file which is output by the deep fake detector smart loudspeaker system 100.

The information overlay unit 104 can computer-generate a warning message x_{warning}, which can have the same format as the audio waveform xϵ [symbol] ⁿ. The warning message x_{warning} can comprise a computer-generated speech message announcing the calculated deepfake probability P_{deepfake,overall} of a audio waveform x or deepfake probability P_{deepfake} of the audio event x₁. The warning message x_{warning} can instead or additionally comprise a computer-generated general warning speech message like “This audio clip is likely a deepfake.”. The warning message x_{warning} can instead or additionally comprise a computer-generated play-out specific warning message like “The following audio clip contains a computer-generated voice that sounds like President Donald J. Trump”, or “The following audio clip is a deepfake with an estimated probability of 75%”. The warning message x_{warning} can instead or additionally comprise a play-out warning melody.

In the embodiment of FIG. 1 (off-line operational mode) the information overlay unit 104 receives the overall deepfake probability P_{deepfake,overall} of an audio waveform xϵ [symbol] ⁿ from the deepfake detector 102 and the stored audio waveform xϵ [symbol] ⁿ. A warning message x_{warning} can be overlaid over the audio waveform xϵ [symbol] ⁿ if the overall deepfake probability P_{deepfake,overall} of the audio waveform xϵ [symbol] ⁿ with is above a predetermined threshold, for example 0.5, or the warning message x_{warning} can be overlaid over the audio waveform xϵ [symbol] ⁿ independently of the overall deepfake probability P_{deepfake,overall} of the audio waveform xϵ [symbol] ⁿ.

In the embodiment of FIG. 2 (on-line operational mode) the information overlay unit 104 receives a deepfake probability P_{deepfake} of the audio event x₁ from the deepfake detector 102 and the currently played part of the audio waveform xϵ [symbol] ⁿ. A warning message x_{warning} can be overlaid over currently played part of the audio waveform xϵ [symbol] ⁿ if the deepfake probability P_{deepfake} of the audio event x₁ with is above a predetermined threshold, for example 0.5, or the warning message x_{warning} can be overlaid over the currently played part of the audio waveform xϵ [symbol] ⁿ independently of the deepfake probability P_{deepfake} of the audio event x₁.

If the audio waveform xϵ [symbol] ⁿ is received by the information overlay unit 104 in off-line mode the warning message x_{warning} can be overlaid over the audio waveform xϵ [symbol] ⁿ by merging the warning message x_{warning} with the audio waveform xϵ [symbol] ⁿ, at any given time of audio waveform xϵ [symbol] ⁿ (i.e. before, during or after the audio waveform xϵ [symbol] ⁿ), which yields a modified audio waveform x′ϵ [symbol] ⁿ. The warning message x_{warning} can be played with a higher amplitude than the audio waveform xϵ [symbol] ⁿ in the modified audio waveform x′ϵ [symbol] ⁿ, for example with the double amplitude. The audio waveform xϵ [symbol] ⁿ can also be cut at any given part and the warning message x_{warning} is inserted, which yields the modified audio waveform x′ϵ [symbol] ⁿ.

If the audio waveform xϵ [symbol] ⁿ is received by the information overlay unit 104 in on-line mode the warning message x_{warning} can be overlaid over the currently played audio waveform xϵ [symbol] ⁿ by live-merging (i.e. the currently played audio waveform xϵ [symbol] ⁿ is buffered for a time period and merged with warning message x_{warning}) the warning message x_{warning} with the currently played audio waveform xϵ [symbol] ⁿ. The warning message x_{warning} can be played with a higher amplitude than the audio waveform xϵ [symbol] ⁿ in the modified audio waveform x′ϵ [symbol] ⁿ, for example with the double amplitude. The currently played audio waveform xϵ [symbol] ⁿ can also be paused/cut and the warning message x_{warning} is inserted, which yields the modified audio waveform x′ϵ [symbol] ⁿ.

In another embodiment, the information overlay unit 104 may output a warning light (turning it on) while playing the audio waveform xϵ [symbol] ⁿ, if the overall deepfake probability P_{deepfake,overall} of the audio waveform xϵ [symbol] ⁿ or the deepfake probability P_{deepfake} of the audio event x₁ is above a pre-determine threshold, for example 0.5.

In another embodiment a screen display may display the overall deepfake probability P_{deepfake,overall} of the audio waveform xϵ [symbol] ⁿ or the deepfake probability P_{deepfake} of the audio event x₁.

In another embodiment a screen display my display a trust level of audio waveform xϵ [symbol] ⁿ, which may be the inverse value of the deepfake probability P_{deepfake,overall} of the audio waveform xϵ [symbol] ⁿ or the deepfake probability P_{deepfake} of the audio event x₁.

In another embodiment the audio waveform xϵ [symbol] ⁿ may be muted completely if the deepfake probability P_{deepfake,overall} of the audio waveform xϵ [symbol] ⁿ or the deepfake probability P_{deepfake} of the audio event x₁ exceeds a certain threshold, for example 0.5. In another embodiment parts of the audio waveform xϵ [symbol] ⁿ for which a deepfake probability P_{deepfake} exceeds a certain threshold, for example 0.5, are muted. In another embodiment separated tracks of the audio waveform xϵ [symbol] ⁿ for which a deepfake probability P_{deepfake} exceeds a certain threshold, for example 0.5, are muted.

### Implementation

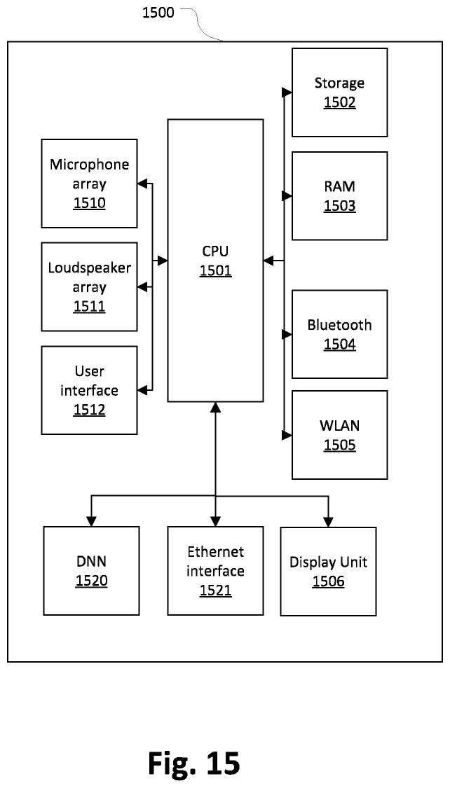

FIG. 15 schematically describes an embodiment of an electronic device which may implement the functionality of a deep fake detector smart loudspeaker system 100. The electronic device 1500 further comprises a microphone array 1510, a loudspeaker array 1511 and a convolutional neural network unit 1520 that are connected to the processor 1501. The processor 1501 may for example implement a pre-processing unit 101, a combination unit 103, a information overlay unit 104 and parts of a deepfake detector 102, as described above. The DNN 1520 may for example be an artificial neural network in hardware, e.g. a neural network on GPUs or any other hardware specialized for the purpose of implementing an artificial neural network. The DNN 1520 may for example implement a source separation with regard to FIG. 3a. Still further, the DNN 1520 may realize the training and operation of the artificial neural network of the deepfake detector 102 as described in FIGS. 6-14. The Loudspeaker array 1511, consists of one or more loudspeakers. The electronic device 1500 further comprises a user interface 1512 that is connected to the processor 1501. This user interface 1512 acts as a man-machine interface and enables a dialogue between an administrator and the electronic system. For example, an administrator may make configurations to the system using this user interface 1512. The electronic device 1500 further comprises an Ethernet interface 1521, a Bluetooth interface 1504, and a WLAN interface 1505. These units 1504, 1505 act as I/O interfaces for data communication with external devices. For example, additional loudspeakers, microphones, and video cameras with Ethernet, WLAN or Bluetooth connection may be coupled to the processor 1501 via these interfaces 1521, 1504, and 1505. The electronic device 1500 further comprises a data storage 1502 and a data memory 1503 (here a RAM). The data memory 1503 is arranged to temporarily store or cache data or computer instructions for processing by the processor 1501. The data storage 1502 is arranged as a long-term storage, e.g. to store audio waveforms or warning messages. The electronic deceive 1500 still further comprises a display unit 1506, which may for example be a screen display for example an LCD display.

Instead of implementing the detection pipeline directly on the chip/silicon level, it would also be possible to implement it as part of the operating system (video/audio driver) or part of the internet browser. For example, the operating system or browser may constantly check the video/audio output the system such that it can automatically detect possible deepfakes and warn the user accordingly.

It should be recognized that the embodiments describe methods with an exemplary ordering of method steps. The specific ordering of method steps is, however, given for illustrative purposes only and should not be construed as binding. For example, steps 1401, 1402 or 1403 in FIG. 14 could be exchanged.

It should also be noted that the division of the electronic device of FIG. 15 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below:
(1) A method comprising determining at least one audio event (x₁) based on an audio waveform (x) and determining a deepfake probability (P_{deepfake}) for the audio event (x₁).
(2) The method of claim 1, wherein the deepfake probability (P_{deepfake}) indicates a probability that the audio waveform (x) has been altered and/or distorted by artificial intelligence techniques or has been completely generated by artificial intelligence techniques.
(3) The method of (1) or (2), wherein the audio waveform (x) relates to media content such as audio or video file or stream.
(4) The method of anyone of (1) to (3), wherein determining at least one audio event (x₁) comprises determining (302) an audio event spectrogram (x₁) of the audio waveform (x) or of a part of the audio waveform (x).
(5) The method of anyone of (1) to (4) further comprising determining (801) the deepfake probability (P_{deepfake}) for an audio event (x₁) with a trained DNN classifier.
(6) The method of anyone of (1) to (5), wherein determining at least one audio event (x₁) comprises performing audio source separation (301) on the audio waveform (x) to obtain a vocal waveform (xᵥ), and wherein the deepfake probability (P_{deepfake}) is determined based the vocal waveform (xᵥ).
(7) The method of anyone of (1) to (6), wherein determining at least one audio event (x₁) comprises performing audio source separation (301) on the audio waveform (x) to obtain a vocal waveform (xᵥ), and wherein the deepfake probability (P_{deepfake}) is determined based on an audio event spectrogram (x₁) of the vocal waveform (xᵥ).
(8) The method of anyone of (1) to (7), wherein determining at least one audio event (x₁) comprises determining (302) one or more candidate spectrograms (s₁, . . . , s_{L}) of the audio waveform (x) or of a part of the audio waveform (x), labeling (502) the candidate spectrograms (s₁, . . . , s_{L}) by a trained DNN classifier, and filtering (503) the labelled spectrograms (s′₁, . . . , s′_{L}) according to their label to obtain the audio event spectrogram (x₁).
(9) The method of anyone of (1) to (8), wherein determining the deepfake probability (P_{deepfake}) for the audio event (x₁) comprises determining an intrinsic dimension probability value (P_{intrinsic}) of the audio event (x₁).
(10) The method of (9), wherein the intrinsic dimension probability value (P_{intrinsic}) is based on a ratio (r_{dim}) of an intrinsic dimension (dimᵢₙₜ) of the audio event (x₁) and a feature space dimension (dim_{feat}) of the audio event (x₁) and an intrinsic dimension probability function (ƒ_{intrinsic}).
(11) The method of (4), wherein determining the deepfake probability (P_{deepfake}) for the audio event spectrogram (x₁) is based on determining an correlation probability value (P_{corr}) of the audio event spectrogram (x₁).
(12) The method of claim (11), wherein the correlation probability value (P_{corr}) is calculated based on a correlation probability function (ƒ_{corr}) and a normalized cross-correlation (corr(\tilde{x}₁, y)) between a resized stored real audio event spectrogram (y) of a recording noise floor and noise-only parts (ii) of the audio event spectrogram (x₁).
(13) The method of anyone of (1) to (12) comprises determining a plurality of audio events (x₁, . . . , x_{K}) based on the audio waveform (x), determining a plurality of deepfake probabilities (P_{deepfake,1}, . . . , P_{deepfake,K}) for the plurality of audio events (x₁, . . . , x_{K}), and determining an overall deepfake probability (P_{deepfake,overall}) of the audio waveform (x) based on the plurality of deepfake probabilities (P_{deepfake,1}, . . . , P_{deepfake,K}).
(14) The method of anyone of (1) to (13) further comprising determining a modified audio waveform (x′) by overlaying a warning message (x_{warning}) over the audio waveform (x) based on the deepfake probability (P_{deepfake}, P_{deepfake,overall}).
(15) The method of anyone of (1) to (14) to further comprising outputting a warning based on the deepfake probability (P_{deepfake}, P_{deepfake,overall}).
(16) The method of anyone of (1) to (15) further comprising outputting a warning if the deepfake probability (P_{deepfake}, P_{deepfake,overall}) is above 0.5.
(17) The method anyone of (1) to (16) wherein the audio waveform (x) is a speech of a person or piece of music.
(18) The method anyone of (1) to (17) wherein the audio waveform (x) is a piece of music which is downloaded from the internet.
(19) The method anyone of (1) to (17) wherein the audio waveform (x) is a piece of music which is streamed from an audio streaming service.
(20) The method of anyone of (1) to (19) which is executed in a user device.
(21) The method of anyone of (1) to (20) which is executed in a smart loudspeaker.
(22) The method of anyone of (3) to (21), wherein a user is a consumer of the media content.
(23) The method of (22), wherein the warning is output to the user to alert him of a deepfake.
(24) An electronic device (100) comprising circuitry configured to determining at least one audio event (x₁) based on an audio waveform (x), and determining a deepfake probability (P_{deepfake}) for the audio event (x₁).
(25) The electronic device (100) of (24), wherein the deepfake probability (P_{deepfake}) indicates a probability that the audio waveform (x) has been altered and/or distorted by artificial intelligence techniques or has been completely generated by artificial intelligence techniques.
(26) The electronic device (100) of (24) or (25), wherein the audio waveform (x) relates to media content such as audio or video file or stream.
(27) The electronic device (100) of anyone of (24) to (26), wherein determining at least one audio event (x₁) comprises determining (302) an audio event spectrogram (x₁) of the audio waveform (x) or of a part of the audio waveform (x).
(28) The electronic device (100) of anyone of (24) to (27) further comprising circuitry configure to determining (801) the deepfake probability (P_{deepfake}) for an audio event (x₁) with a trained DNN classifier.
(29) The electronic device (100) of anyone of (24) to (28), wherein determining at least one audio event (x₁) comprises performing audio source separation (301) on the audio waveform (x) to obtain a vocal waveform (xᵥ), and wherein the deepfake probability (P_{deepfake}) is determined based the vocal waveform (xᵥ).
(30) The electronic device (100) of anyone of (24) to (29), wherein determining at least one audio event (x₁) comprises performing audio source separation (301) on the audio waveform (x) to obtain a vocal waveform (xᵥ), and wherein the deepfake probability (P_{deepfake}) is determined based on an audio event spectrogram (x₁) of the vocal waveform (xᵥ).
(31) The electronic device (100) of anyone of (24) to (30), wherein determining at least one audio event (x₁) comprises determining (302) one or more candidate spectrograms (s₁, . . . , s_{L}) of the audio waveform (x) or of a part of the audio waveform (x), labeling (502) the candidate spectrograms (s₁, . . . , s_{L}) by a trained DNN classifier, and filtering (503) the labelled spectrograms (s′₁, . . . , s′_{L}) according to their label to obtain the audio event spectrogram (x₁).
(32) The electronic device (100) of anyone of (24) to (31), wherein determining the deepfake probability (P_{deepfake}) for the audio event (x₁) comprises determining an intrinsic dimension probability value (P_{intrinsic}) of the audio event (x₁).
(33) The electronic device (100) of (32), wherein the intrinsic dimension probability value (P_{intrinsic}) is based on a ratio (r_{dim}) of an intrinsic dimension (dimᵢₙₜ) of the audio event (x₁) and a feature space dimension (dim_{feat}) of the audio event (x₁) and an intrinsic dimension probability function (ƒ_{intrinsic}).
(34) The electronic device (100) of (27), wherein determining the deepfake probability (P_{deepfake}) for the audio event spectrogram (x₁) is based on determining an correlation probability value (P_{corr}) of the audio event spectrogram (x₁).
(35) The electronic device (100) of (34), wherein the correlation probability value (P_{corr}) is calculated based on a correlation probability function (ƒ_{corr}) and a normalized cross-correlation (corr(x₁, y)) between a resized stored real audio event spectrogram (y) of a recording noise floor and noise-only parts (ii) of the audio event spectrogram (x₁).
(36) The electronic device (100) of anyone of (1) to (35) further comprises circuitry configure to determining a plurality of audio events (x₁, . . . , x_{K}) based on the audio waveform (x), determining a plurality of deepfake probabilities (P_{deepfake,1}, . . . , P_{deepfake,K}) for the plurality of audio events (x₁, . . . , x_{K}), and determining an overall deepfake probability (P_{deepfake,overall}) of the audio waveform (x) based on the plurality of deepfake probabilities (P_{deepfake,1}, . . . , P_{deepfake,K}).
(37) The electronic device (100) of anyone of (24) to (36) further comprises circuitry configure to determining a modified audio waveform (x′) by overlaying a warning message (x_{warning}) over the audio waveform (x) based on the deepfake probability (P_{deepfake}, P_{deepfake,overall}).
(38) The electronic device (100) of anyone of (24) to (37) further comprises circuitry configure to outputting a warning based on the deepfake probability (P_{deepfake}, P_{deepfake,overall}).
(39) The electronic device (100) of anyone of (24) to (38) further comprises circuitry configure to outputting a warning if the deepfake probability (P_{deepfake}, P_{deepfake,overall}) is above 0.5.
(40) The electronic device (100) of anyone of (24) to (39), wherein the audio waveform (x) is a speech of a person or piece of music.
(41) The electronic device (100) of anyone of (24) to (40), wherein the audio waveform (x) is a piece of music which is downloaded from the internet.
(42) The electronic device (100) of anyone of (24) to (41), wherein the audio waveform (x) is a piece of music which is streamed from an audio streaming service.
(43) The electronic device (100) of anyone of (24) to (42), wherein the electronic device (100) is a user device.
(44) The electronic device (100) of anyone of (24) to (43), wherein the electronic device (100) is a smart loudspeaker.
(45) The electronic device (100) of anyone of (26) to (44), wherein a user is a consumer of the media content.
(46) The electronic device (100) of (45), wherein the warning is output to the user to alert him of a deepfake.

1. A method comprising determining at least one audio event based on an audio waveform and determining a deepfake probability for the audio event.

2. The method of claim 1, wherein the deepfake probability indicates a probability that the audio waveform has been altered and/or distorted by artificial intelligence techniques or has been completely generated by artificial intelligence techniques.

3. The method of claim 1, wherein the audio waveform relates to media content such as audio or video file or stream.

4. The method of claim 1, wherein determining at least one audio event comprises determining an audio event spectrogram of the audio waveform or of a part of the audio waveform.

5. The method of claim 1 further comprising determining the deepfake probability for an audio event with a trained DNN classifier.

6. The method of claim 1, wherein determining at least one audio event comprises performing audio source separation on the audio waveform to obtain a vocal or speech waveform, and wherein the deepfake probability is determined based on an audio event spectrogram of the vocal or speech waveform

7. The method of claim 1, wherein determining at least one audio event comprises determining one or more candidate spectrograms of the audio waveform or of a part of the audio waveform, labeling the candidate spectrograms by a trained DNN classifier, and filtering the labelled spectrograms according to their label to obtain the audio event spectrogram.

8. The method of claim 1, wherein determining the deepfake probability for the audio event comprises determining an intrinsic dimension probability value of the audio event.

9. The method of claim 8, wherein the intrinsic dimension probability value is based on a ratio of an intrinsic dimension of the audio event and a feature space dimension of the audio event and an intrinsic dimension probability function.

10. The method of claim 4, wherein determining the deepfake probability for the audio event spectrogram is based on determining a correlation probability value of the audio event spectrogram.

11. The method of claim 10, wherein the correlation probability value is calculated based on a correlation probability function and a normalized cross-correlation between a resized stored real audio event spectrogram of a recording noise floor and noise-only parts of the audio event spectrogram.

12. The method of claim 1 comprises determining a plurality of audio events based on the audio waveform, determining a plurality of deepfake probabilities for the plurality of audio events, and determining an overall deepfake probability of the audio waveform based on the plurality of deepfake probabilities.

13. The method of claim 1 further comprising determining a modified audio waveform by overlaying a warning message over the audio waveform based on the deepfake probability.

14. The method of claim 1 further comprising outputting a warning based on the deepfake probability.

15. An electronic device comprising circuitry configured to determining at least one audio event based on an audio waveform, and determining a deepfake probability for the audio event.
